(19) United States
(12) Patent Application Publication
(10) Pub. No.: US 2011/0193969 A1
(43) Pub. Date: Aug. 11, 2011

(54) OBJECT-DETECTING SYSTEM AND METHOD BY USE OF NON-COINCIDENT FIELDS OF LIGHT

(75) Inventors: Hua-Chun Tsai, Taoyuan (TW); Chun-Jen Lee, Taoyuan (TW); Cheng-Kuan Chang, Taoyuan (TW); Yu-Chih Lai, Taoyuan (TW); Chao-Kai Mao, Taoyuan (TW); Wei-Che Sheng, Taoyuan (TW)

(73) Assignee: QISDA CORPORATION, Taoyuan (TW)

(21) Appl. No.: 13/023,553

(22) Filed: Feb. 9, 2011

(30) Foreign Application Priority Data
Feb. 9, 2010 (TW) 099103874
Aug. 11, 2010 (TW) 099126731

(51) Int. Cl. H04N 5/225

(52) U.S. Cl. 348/169; 348/E05.024

(57) ABSTRACT

The invention provides an object-detecting system and method for detecting information of an object located in an indicating space. In particular, the invention is to capture images relative to the indicating space by use of non-coincident fields of light, and further to determine the information of the object located in the indicating space. The invention also preferably sets the operation times of image-capturing units and the exposure times of light-emitting units in the object-detecting system to improve the quality of the captured images.

### CROSS-REFERENCE TO RELATED APPLICATION

This utility application claims priority to Taiwan Application Serial Number 099103874, filed Feb. 9, 2010, and Taiwan Application Serial Number 099126731, filed Aug. 11, 2010, which are incorporated herein by reference.

### BACKGROUND OF THE INVENTION

1. Field of the Invention

The present invention relates to an object-detecting system and method, and more particularly, to an object-detecting system and method by use of non-coincident fields of light and single-line image sensor.

2. Description of the Prior Art

Because of the advantages of intuited operation of user by touch to input the coordinates corresponding to a monitor, the touch screen has been a common input apparatus equipped with the monitor. Touch screen has been widely used in electronic products with a screen, such as monitors, notebook computers, tablet computers, auto teller machine (ATM), Point-of-Sale (POS) terminal, tourist guiding system, and industrial control system.

Except for the traditional resistive touch screen and capacitive touch screen that users have to touch to operate, users can also input the coordinates without touching the screen by using image-capturing device. The prior art related to non-contact touch screen (or called optical touch screen) by using image-capturing unit has been disclosed in U.S. Pat. No. 4,507,557, and discussion of unnecessary details will be hereby omitted.

To analyze the position of input point more precisely or to support multi-touch, certain of design solutions about different types of light source, light-reflecting device and light-guiding device have been proposed to provide more angular functions related to the positions of input points to analyze the positions. For example, U.S. Pat. No. 7,460,110 discloses an apparatus includes a waveguide, mirrors extend along both sides of the waveguide, and light source to form an upper layer and a lower layer of coincident fields of light simultaneously. Accordingly, the image-capturing unit can capture images of the upper layer and the lower layer simultaneously.

However, it is necessary to use expansive image sensor like an area image sensor, a multiple-line image sensor or a double-line image sensor to capture the images of the upper layer and the lower layer simultaneously. Moreover, the optical touch screen needs more operating resource to analyze the image captured by the area image sensor, the multiple-line image sensor and the double-line image sensor, especially the area image sensor. Additionally, the image sensors, especially the double-line image sensor, may sense wrong fields of light or fail to sense the field of light because of the assembly error of the optical touch screen.

Accordingly, an aspect of the present invention is to provide an object-detecting system and method for detecting a target position of an object on an indicating plane by using optical approach. Particularly, the object-detecting system and method of the invention apply non-coincident fields of light and single-line image sensors to solve the problems of the prior art.

Additionally, another aspect of the invention is to provide an object-detecting system and method for detecting information, such as an object shape, an object area, an object stereo-shape and an object volume, of an object in the indicating space including the indicating plane.

Additionally, another aspect of the invention is to provide preferred settings of the operation times of image-capturing units and the exposure times of light-emitting units in the object-detecting system to improve the quality of the captured images.

### SUMMARY OF THE INVENTION

An object-detecting system, according to the first preferred embodiment of the invention, includes a peripheral member, a light-reflecting device, a controlling/processing unit, a first light-emitting unit, a second light-emitting unit, a third light-emitting unit, and a first image-capturing unit. The peripheral member defines an indicating space and an indicating plane of the indicating space on which an object directs a target position. The peripheral member has a relationship with the object. The indicating space defines a first side, a second side adjacent to the first side, a third side adjacent to the second side, and a fourth side adjacent to the third side and the first side. The third side and the fourth side form a first edge. The light-reflecting device is disposed on the peripheral member and located at the first side. The light-reflecting device is disposed on the peripheral member and located at the first side. The first light-emitting unit is electrically connected to the controlling/processing unit, disposed on the peripheral member, and located at the first side. The first light-emitting unit is controlled by the controlling/processing unit to emit a first light which passes through the indicating space to form a first field of light. The second light-emitting unit is electrically connected to the controlling/processing unit, disposed on the peripheral member, and located at the second side. The third light-emitting unit is electrically connected to the controlling/processing unit, disposed on the peripheral member, and located at the third side. The third light-emitting unit is controlled by the controlling/processing unit to emit a second light which passes through the indicating space to form a second field of light. The second light-emitting unit is controlled by the controlling/processing unit to selectively emit the first light synchronously or asynchronously with the first light-emitting unit, or to selectively emit the second light synchronously or asynchronously with the third light-emitting unit. The first image-capturing unit is electrically connected to the controlling/processing unit, and disposed around of the first edge. The first image-capturing unit defines a first image-capturing point. The first image-capturing unit is controlled by the controlling/processing unit to capture a first image on the first side of the indicating space, and selectively capture a second image on the second side of the indicating space and a first reflected image reflected by the light reflecting device on the second side of the indicating space when the first field of light is formed. The first image-capturing unit is also controlled by the controlling/processing unit to capture a second reflected image reflected by the light reflecting device on the third side of the indicating space and selectively capture a third image on the second side of the indicating space and a third reflected image reflected by the light reflecting device on the second side of the indicating space when the second field of light is formed. Moreover, the controlling/processing unit processes the first image and the second reflected image and selectively processes at least two among the second image, the first reflected image, the third image and the third reflected image to determine an object information of the object located in the indicating space.

In one embodiment, the light-reflecting device is a plane mirror.

In another embodiment, the light-reflecting device includes a first reflecting surface and a second reflecting surface. The first reflecting surface and the second reflecting surface are substantially perpendicular to each other and toward to the indicating space. The indicating plane defines a main extending surface. The first reflecting surface defines a first sub-extending surface, and the second reflecting surface defines a second sub-extending surface. The first sub-extending surface and the second first sub-extending surface meet the main extending surface at an angle of 45°.

In one embodiment, the first image-capturing unit is a line image sensor.

In one embodiment, the controlling/processing unit stores a plurality of operation times. Each of the operation time includes at least one exposure time. Each of the first light-emitting unit, the second light-emitting unit and the third light-emitting unit corresponds to at least one of the exposure times. The controlling/processing unit controls each of the light-emitting units to emit the first light and/or the second light in accordance with the at least one exposure time corresponding to said one light-emitting unit. The controlling/processing unit also controls the first image-capturing unit to capture the images within each of the operation times.

In another embodiment, the object-detecting system according to the first preferred embodiment of the invention further includes a fourth light-emitting unit and a second image-capturing unit. The second side and the third side form a second edge. The fourth light-emitting unit is electrically connected to the controlling/processing unit, disposed on the peripheral member, and located at the fourth side. The fourth light-emitting unit is controlled by the controlling/processing unit to selectively emit the first light synchronously or asynchronously with the first light-emitting unit, or to selectively emit the second light synchronously or asynchronously with the third light-emitting unit. The second image-capturing unit is electrically connected to the controlling/processing unit, and disposed around the second edge. The second image-capturing unit is controlled by the controlling/processing unit to capture a fourth image on the first side of the indicating space, and selectively to capture a fifth image on the fourth side of the indicating space and a fourth reflected image reflected by the light reflecting device on the fourth side of the indicating space when the first field of light is formed. The second image-capturing unit is controlled by the controlling/processing unit to capture a fifth reflected image reflected by the light reflecting device on the third side of the indicating space, and selectively to capture a sixth image on the fourth side of the indicating space and a sixth reflected image reflected by the light reflecting device on the fourth side of the indicating space when the second field of light is formed. The controlling/processing unit processes the first image, the second reflected image, the fourth image and the fifth reflected image and selectively processes at least two among the second image, the first reflected image, the third reflected image, the third image, the fifth image, the fourth reflected image, the sixth image and the sixth reflected image to determine the object information of the object located in the indicating space.

In one embodiment, the second image-capturing unit is a line image sensor.

In one embodiment, each of the first light-emitting unit, the second light-emitting unit, the third light-emitting unit and the fourth light-emitting unit is a line light source.

According to the second preferred embodiment of the invention, the basic elements to perform the object-detecting method of the invention includes a peripheral member, a light-reflecting device, a first light-emitting unit, a second light-emitting unit and a third light-emitting unit. The peripheral member defines an indicating space and an indicating plane of the indicating space on which an object directs a target position. The peripheral member has a relationship with the object. The indicating space defines a first side, a second side adjacent to the first side, a third side adjacent to the second side, and a fourth side adjacent to the third side and the first side. The light-reflecting device is disposed on the peripheral member, and located at the first side. The first light-emitting unit is disposed on the peripheral member, and located at the first side. The second light-emitting unit is disposed on the peripheral member, and located at the second side. The third light-emitting unit is disposed on the peripheral member, and located at the third side. The object-detecting method according to the invention is first to control the first light-emitting unit to emit a first light, and selectively to control the second light-emitting unit to emit the first light synchronously or asynchronously with the first light-emitting unit, where the first light passes through the indicating space to form a first field of light. Then, the object-detecting method according to the invention is to capture a first image on the first side of the indicating space, and selectively to capture a second image on the second side of the indicating space and a first reflected image reflected by the light reflecting device on the second side of the indicating space when the first field of light is formed. Next, the object-detecting method according to the invention is to control the third light-emitting unit to emit a second light, and selectively to control the second light-emitting unit to emit the second light synchronously or asynchronously with the third light-emitting unit, where the second light passes through the indicating space to form a second field of light. Ten, the object-detecting method according to the invention is to capture a second reflected image reflected by the light reflecting device on the third side of the indicating space, and selectively to capture a third image on the second side of the indicating space and a third reflected image reflected by the light reflecting device on the second side of the indicating space when the second field of light is formed. Finally, the object-detecting method according to the invention is to process the first image, the second reflected image, and selectively to process at least two among the second image, the first reflected image, the third reflected image, the third image to determine the object information of the object located in the indicating space.

An object-detecting system according to the third preferred embodiment of the invention is implemented on an indicating plane which an object directs a target position on. The object-detecting system according to the invention includes a first image-capturing unit, a plurality of light-emitting units and a controlling/processing unit. The first image-capturing unit is disposed around a first edge of the indicating plane. The plurality of light-emitting units are disposed around a peripheral of the indicating plane. The controlling/processing unit stores a plurality of operation times. Each of the operation time includes at least one exposure time. Each of the light-emitting units corresponds to at least one of the exposure times. The controlling/processing unit controls each of the light-emitting units to emit light in accordance with the at least one exposure time corresponding to said one light-emitting unit. The controlling/processing unit also controls the first image-capturing unit to capture images relative to the indicating plane within each of the operation times.

In one embodiment, each of the exposure times is less than or equivalent to the operation time that said one exposure time is within.

In one embodiment, all of the operation times are equivalent and do not overlap one another, and all of the exposure times are equivalent.

In one embodiment, all of the operation times are equivalent and do not overlap one another, and at least one of the exposure times is not equivalent to the others.

In one embodiment, at least two of the operation times overlap one another.

In another embodiment, the object-detecting system according to the third embodiment of the invention further includes a peripheral member and a light-reflecting device. The peripheral member defines an indicating space and the indicating plane of the indicating space. The peripheral member has a relationship with the object. The indicating space defines a first side, a second side adjacent to the first side, a third side adjacent to the second side, and a fourth side adjacent to the third side and the first side. The third side and the fourth side form the first edge. The plurality of light-emitting units include a first light-emitting unit, a second light-emitting unit and a third light-emitting unit. The first light-emitting unit is located at the first side. The first light-emitting unit is controlled by the controlling/processing unit to emit a first light which passes through the indicating space to form a first field of light. The second light-emitting unit is located at the second side. The third light-emitting unit is located at the third side. The third light-emitting unit is controlled by the controlling/processing unit to emit a second light which passes through the indicating space to form a second field of light. The second light-emitting unit is controlled by the controlling/processing unit to selectively emit the first light synchronously or asynchronously with the first light-emitting unit, or to selectively emit the second light synchronously or asynchronously with the third light-emitting unit. The first image-capturing unit defines a first image-capturing point. The first image-capturing unit is controlled by the controlling/processing unit to capture a first image on the first side of the indicating space, and selectively capture a second image on the second side of the indicating space and a first reflected image reflected by the light reflecting device on the second side of the indicating space when the first field of light is formed. The first image-capturing unit is also controlled by the controlling/processing unit to capture a second reflected image reflected by the light reflecting device on the third side of the indicating space and selectively capture a third image on the second side of the indicating space and a third reflected image reflected by the light reflecting device on the second side of the indicating space when the second field of light is formed. The controlling/processing unit processes the first image and the second reflected image and selectively processes at least two among the second image, the first reflected image, the third image and the third reflected image to determine an object information of the object located in the indicating space.

According to the fourth preferred embodiment of the invention, the basic elements to perform the object-detecting method of the invention includes an indicating plane, a plurality of light-emitting units and a plurality of operation times. An object directs a target position on the indicating plane. The plurality of light-emitting units are disposed around a peripheral of the indicating plane. The plurality of operation times are provided. Each of the operation time has at least one exposure time. Each of the light-emitting units corresponds to at least one of the exposure times. The object-detecting method according to the invention is first to control each of the light-emitting units to emit light in accordance with the at least one exposure time corresponding to said one light-emitting unit. Finally, the object-detecting method according to the invention is to capture images relative to the indicating plane within each of the operation times.

The advantage and spirit of the invention may be understood by the following recitations together with the appended drawings.

### BRIEF DESCRIPTION OF THE APPENDED DRAWINGS

FIG. 1A shows the object-detecting system according to the first preferred embodiment of the invention.

FIG. 1B is a sectional view along line A-A of the first light-emitting unit, the light-reflecting device and the peripheral member of FIG. 1A.

FIG. 2A illustrates the input points P1 and P2 obstruct the pathways of the light to the first image-capturing unit and the second image-capturing unit when the first field of light and the second field of light are formed.

FIG. 2B illustrates an example showing that the first image-capturing unit captures an image related to the first field of light and an image related to the second field of light at time T0 and T1 respectively.

FIG. 2C illustrates an example showing that the second image-capturing unit captures an image related to the first field of light and an image related to the second field of light at time T0 and T1 respectively.

FIG. 3 shows a flow chart of an object-detecting method according t the second preferred embodiment of the invention.

FIG. 4 is a timing diagram of the operation times and the exposure times of an example of the invention.

FIG. 5 is a timing diagram of the operation times and the exposure times of another example of the invention.

FIG. 6 is a timing diagram of the operation times and the exposure times of another example of the invention.

FIG. 7 is a timing diagram of the operation times and the exposure times of another example of the invention.

FIG. 8 is a timing diagram of the operation times and the exposure times of another example of the invention.

FIG. 9 is a timing diagram of the operation times and the exposure times of another example of the invention.

FIG. 10 shows a flow chart of an object-detecting method according t the fourth preferred embodiment of the invention.

### DETAILED DESCRIPTION OF THE INVENTION

The invention provides an object-detecting system and method for detecting a target position of an object on an indicating plane by using optical approach. Additionally, the object-detecting system and method of the invention can detect information, such as an object shape, an object area, an object stereo-shape and an object volume, of an object in the indicating space including the indicating plane. Particularly, the object-detecting system and method of the invention apply non-coincident fields of light. Therefore, the object-detecting system and method of the invention can be operated with cheaper image sensor and less calculation resource.

The objective of the present invention will no doubt become obvious to those of ordinary skill in the art after reading the following detailed description of the preferred embodiment, which is illustrated in the various figures and drawings.

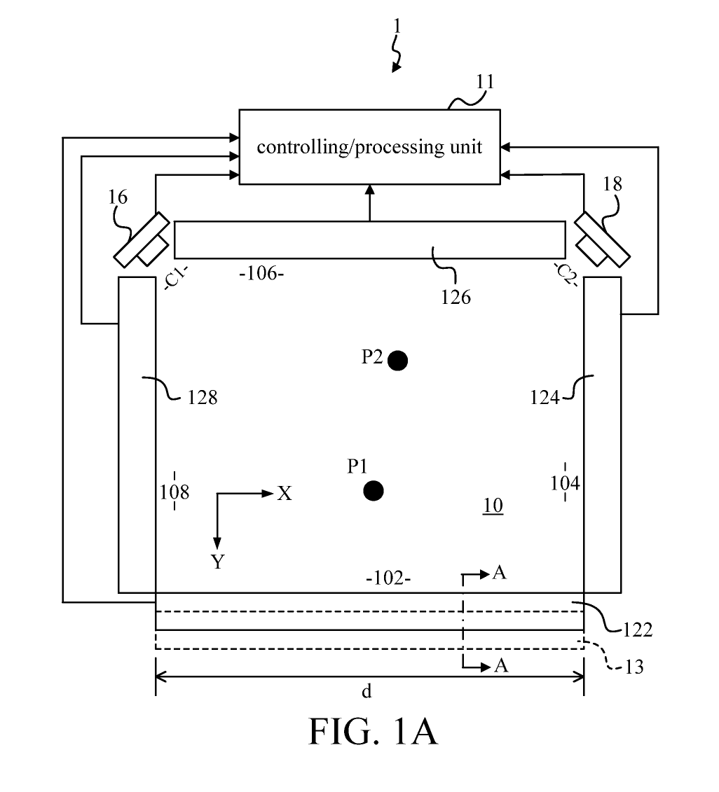

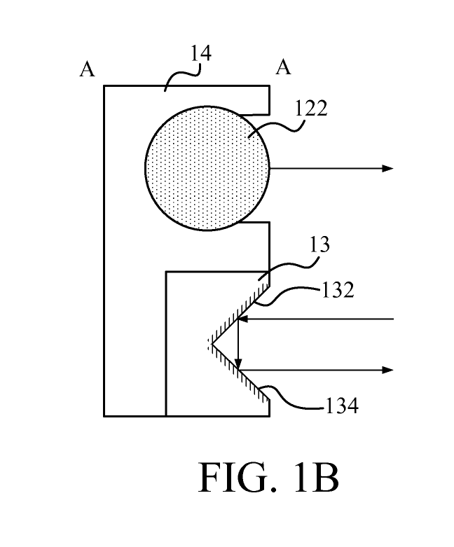

Referring to FIG. 1A and FIG. 1B, FIG. 1A shows the object-detecting system 1 according to the first preferred embodiment of the invention, and FIG. 1B is a sectional view along line A-A of the first light-emitting unit 122, the light-reflecting device 13 and the peripheral member 14 of FIG. 1A. The object-detecting system 1 is used for detecting the location (e.g. the locations (P1, P2) as shown in FIG. 1A) of at least an object (e.g. a finger, a point pen, etc.) on the indicating plane 10.

As shown in FIG. 1A, the object-detecting system 1 according to the invention includes a peripheral member 14 (as shown in FIG. 1B), a light-reflecting device 13, a controlling/processing unit 11, a first light-emitting unit 122, a second light-emitting unit 124, and a third light-emitting unit 126 and a first image-capturing unit 16.

The peripheral member 14 defines an indicating space and an indicating plane 10 of the indicating space on which an object directs the target positions (P1, P2). The peripheral member 14 has a relationship with the object. The indicating plane 10 has a first side 102, a second side 104 adjacent to the first side 102, a third side 106 adjacent to the second side 104, and a fourth side 108 adjacent to the third side 106. The third side 106 and the fourth side 108 form a first edge C1, and the second side 104 and the third side 106 form a second edge C2.

As shown in FIG. 1A, the first light-emitting unit 122 is electrically connected to the controlling/processing unit 11. The first light-emitting unit 122 is disposed on the peripheral member 14 and located at the first side 102. The light-reflecting device 13 is disposed on the peripheral member 14 and located at the first side 102. The second light-emitting unit 124 is electrically connected to the controlling/processing unit 11. The second light-emitting unit 124 is disposed on the peripheral member 14 and located at the second side 104. The third light-emitting unit 126 is electrically connected to the controlling/processing unit 11. The third light-emitting unit 126 is disposed on the peripheral member 14 and located at the third side 106. The first image-capturing unit 16 is electrically connected to the controlling/processing unit 11 and disposed at the periphery of the first edge C2. The first image-capturing unit 16 defines a first image-capturing point.

As shown in FIG. 1B, the peripheral member 14 of the object-detecting system 1 is protruded and surrounding the indicating plane 10. The peripheral member 14 can be used to support the first light-emitting unit 122, the light-reflecting device 13, the second light-emitting unit 124, the third light-emitting unit 126 and the first image-capturing unit 16.

In one embodiment, the light-reflecting device 13 can be a plane minor.

In another embodiment, as shown in FIG. 1B, the light-reflecting device 13 further includes a first reflecting surface 132 and a second reflecting surface 134. The first reflecting surface 132 and the second reflecting surface 134 are substantially perpendicular to each other and toward to the indicating space. The indicating plane 10 defines a main extending surface. The first reflecting surface 132 defines a first sub-extending surface, and the second reflecting surface 134 defines a second sub-extending surface. The first sub-extending surface and the second first sub-extending surface meet the main extending surface at an angle of 45°. In practice, the light-reflecting device 13 can be a prism.

The first light-emitting unit 122 is controlled by the controlling/processing unit 11 to emit a first light. The first light passes through the indicating space to form a first field of light. The third light-emitting unit 126 is controlled by the controlling/processing unit 11 to emit a second light. The second light passes through the indicating space to form a second field of light. The second light-emitting unit 124 is controlled by the controlling/processing unit 11 to selectively emit the first light synchronously or asynchronously with the first light-emitting unit 122, or to selectively emit the second light synchronously or asynchronously with the third light-emitting unit 126. Particularly, the controlling/processing unit 11 controls the first field of light and the second field of light formed not at the same time.

The first image-capturing unit 16 is controlled by the controlling/processing unit 11 to capture a first image on the first side 102 of the indicating space, and selectively capture a second image on the second side 104 of the indicating space and a first reflected image reflected by the light reflecting device 13 on the second side 104 of the indicating space when the first field of light is formed. The first image-capturing unit 16 is also controlled by the controlling/processing unit 11 to capture a second reflected image reflected by the light reflecting device 13 on the third side 106 of the indicating space and selectively capture a third image on the second side 104 of the indicating space and a third reflected image reflected by the light reflecting device 13 on the second side 104 of the indicating space when the second field of light is formed. These images and reflected image include the obstruction of the object to the first light and the second light in the indicating space, that is, the shadow projected on these images and reflected images.

Finally, the controlling/processing unit 11 processes the first image and the second reflected image and selectively processes at least two among the second image, the first reflected image, the third image and the third reflected image to determine an object information of the object located in the indicating space.

In practice, the first image-capturing unit 16 can be a line image sensor.

In one embodiment, the object information includes a relative position of the target position relating to the indicating plane 10. The controlling/processing unit 11 determines a first object point based on the object on the first side 102 in the first image or the object on the second side 104 in the second image. The controlling/processing unit 11 also determines a first reflective object point according to the object on the second side 104 and the third side 106 in the first reflected image. The controlling/processing unit 11 also determines a first direct path according to the connective relationship between the first image-capturing point and the first object point, and determines a first reflective path according to the connective relationship between the first image-capturing point and the first object point and the light-reflecting device 13. Furthermore, the controlling/processing unit 11 determines the relative position based on the intersection of the first direct path and the first reflective path.

In one embodiment, the object information includes object shape and/or an object area of the object projected on the indicating plane 10. The controlling/processing unit 11 determines a first object point and a second object point according to the object on the first side 102 in the first image or the object on the second side 104 in the second image. The controlling/processing unit 11 also determines a first reflective object point and a second reflective object point according to the object on the second side 104 and the third side 106 in the first reflected image. The controlling/processing unit 11 further determines a first direct planar-path according to the connective relationship between the first object point and the second object point, and determines a first reflective planar-path according to the connective relationship between the first image-capturing point and the first reflective object point, the connective relationship between the first image-capturing point and the second reflective object point, and the first light-reflecting device. Moreover, the controlling/processing unit 11 determines the object shape and/or the object area of the object according to the shape and/or the area of the intersection region of the first direct planar-path and the first reflective planar-path. Furthermore, the object information includes the object stereo-shape and/or the object volume of the object located in the indicating space. The controlling/processing unit 11 also separates the first image, the second image and the first reflected image to a plurality of first sub-images, a plurality of second sub-images and a plurality of first reflective sub-images respectively. The controlling/processing unit 11 further determines a plurality of object shapes and/or a plurality of object areas according to the first sub-images, the second sub-images and the first reflective sub-images, and stacks the object shapes and/or the object areas along a normal direction of the indicating plane 10 to determine the object stereo-shape and/or the object volume of the object.

In one embodiment, the object information includes an object stereo-shape and/or an object volume of the object located in the indicating space. The controlling/processing unit 11 determines at least three object points according to the object on the first side 102 in the first image or the object on the second side 104 in the second image. The controlling/processing unit 11 also determines at least three reflective object points according to the object on the second side 104 and the third side 106 in the first reflected image. The controlling/processing unit 11 further determines a first direct stereo-path according to the connective relationship between the first image-capturing point and the at least three object points, and determines a first reflective stereo-path according to the connective relationship between the first image-capturing point and the at least three reflective object points and the light-reflecting device 13, and determines the object stereo-shape and/or the object volume of the object according to the stereo-shape and/or the volume of the intersection space of the first direct stereo-path and the first reflective stereo-path.

In another embodiment of the present invention, the controlling/processing unit 11 stores a plurality of operation times. Each of the operation time includes at least one exposure time. Each of the first light-emitting unit 122, the second light-emitting unit 124 and the third light-emitting unit 126 corresponds to at least one of the exposure times. The controlling/processing unit 11 controls each of the first light-emitting unit 122, the second light-emitting unit 124 and the third light-emitting unit 126 to emit the first light and/or the second light in accordance with the at least one exposure time corresponding to said one light-emitting unit (122, 124, 126). The controlling/processing unit 11 also controls the first image-capturing unit 16 to capture these images and reflected images within each of the operation times.

In one embodiment, each of the exposure times is less than or equivalent to the operation time that said one exposure time is within. In another embodiment, all of the operation times are equivalent and do not overlap one another, and all of the exposure times are equivalent. In another embodiment, all of the operation times are equivalent and do not overlap one another, and at least one of the exposure times is not equivalent to the others. In another embodiment, at least two of the operation times overlap one another.

As shown in FIG. 1A, the object-detecting system 1 of the first preferred embodiment further includes a fourth light-emitting unit 128 and a second image-capturing unit 18. The fourth light-emitting unit 128 is electrically connected to the controlling/processing unit 11. The fourth light-emitting unit 128 is disposed on the peripheral member 14 and located at the fourth side 108. The fourth light-emitting unit 128 is controlled by the controlling/processing unit 11 to selectively emit the first light synchronously or asynchronously with the first light-emitting unit 122, or to selectively emit the second light synchronously or asynchronously with the third light-emitting unit 126.

The second image-capturing unit 18 is electrically connected to the controlling/processing unit 11, and is disposed around the second edge C2. The second image-capturing unit 18 further defines a second image-capturing point. The second image-capturing unit 18 is controlled by the controlling/processing unit 11 to capture a fourth image on the first side 102 of the indicating space, and selectively to capture a fifth image on the fourth side 108 of the indicating space and a fourth reflected image reflected by the light reflecting device 13 on the fourth side 108 of the indicating space when the first field of light is formed. The second image-capturing unit 18 is controlled by the controlling/processing unit 11 to capture a fifth reflected image reflected by the light reflecting device 13 on the third side 106 of the indicating space, and selectively to capture a sixth image on the fourth side 108 of the indicating space and a sixth reflected image reflected by the light reflecting device 13 on the fourth side 108 of the indicating space when the second field of light is formed.

In the preferred embodiment, the controlling/processing unit 11 processes the first image, the second reflected image, the fourth image and the fifth reflected image and selectively processes at least two among the second image, the first reflected image, the third reflected image, the third image, the fifth image, the fourth reflected image, the sixth image and the sixth reflected image to determine the object information of the object located in the indicating space.

In practice, the second image-capturing unit 18 can be a line image sensor.

In practice, each of the first light-emitting unit 122, the second light-emitting unit 124, the third light-emitting unit 126 and the fourth light-emitting unit 128 can be a line light source. Moreover, the line light source (122, 124, 126 and 128) can be formed by a stick light-guiding device and a light-emitting diode (such as an infrared light-emitting diode) disposed on one end of the stick light-guiding. The light emitted by the light-emitting diode to the end of the stick light-guiding device which can guide the light to the indicating plane 10. Furthermore, the line light source (122, 124, 126 and 128) can be a series of light-emitting diodes.

In practice, the background values of these reflected images are weak, so that the determination of the shadows mirror projected in these reflected images would be affected. To solve the problem, the controlling/processing unit 11 can turn on the second light-emitting unit 124, the third light-emitting unit 126, the fourth light-emitting unit 128, the first image-capturing unit 16 and the second image-capturing unit 18 longer or twice to let the time of exposure of these reflected images be longer than those of other images. Moreover, we can make the quantity of illumination of the second field of light higher than that of the first field of light by controlling the gain value of the first light-emitting unit 122, the second light-emitting unit 124, the third light-emitting unit 126 and the fourth light-emitting unit 128; the driving electric current of the light-emitting diode; or the number of ignited light-emitting diode.

To improve the quality of the captured images, in one embodiment, the controlling/processing unit 11 stores a plurality of operation times. Each of the operation times includes at least one exposure time. The first image-capturing unit 16 and the second image-capturing unit 18 respectively correspond to at least one of the operation times. Each of the first light-emitting unit 122, the second light-emitting unit 124, the third light-emitting unit 126 and the fourth light-emitting unit 128 corresponds to at least one of the exposure times. The controlling/processing unit 11 controls each of the first light-emitting unit 122, the second light-emitting unit 124, the third light-emitting unit 126 and the fourth light-emitting unit 128 to emit the first light and/or the second light in accordance with the at least one exposure time corresponding to said one light-emitting unit (122, 124, 126, 128). The controlling/processing unit 11 also controls the first image-capturing unit 16 to capture the images within each of the operation times corresponding to the first image-capturing unit 16, and controls the second image-capturing unit 18 to capture the images within each of the operation times corresponding to the second image-capturing unit 18.

The situation of the object-detecting system 1 of the invention forms the fields of light and the images captured by the system are described with an example of two input points (P1, P2) in the indicating plane 10 of FIG. 1A, the first image-capturing unit 16 and the second image-capturing unit 18.

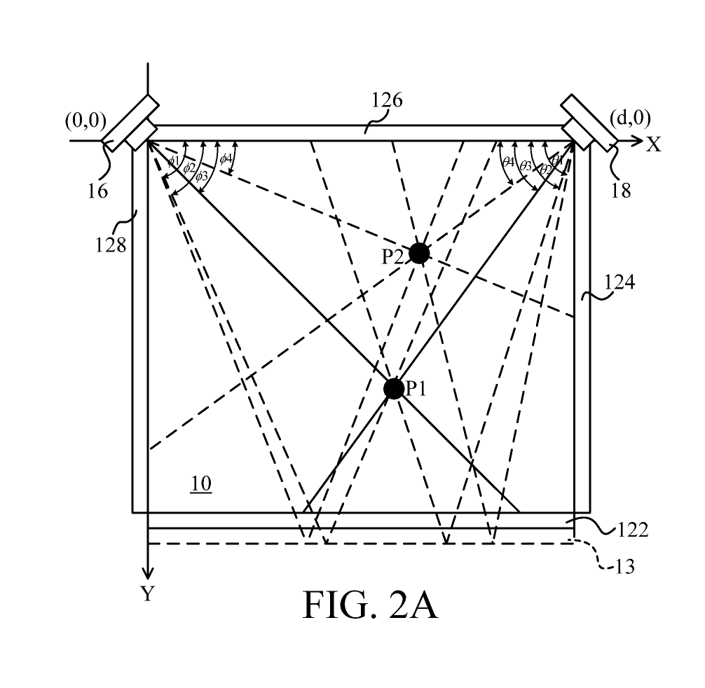

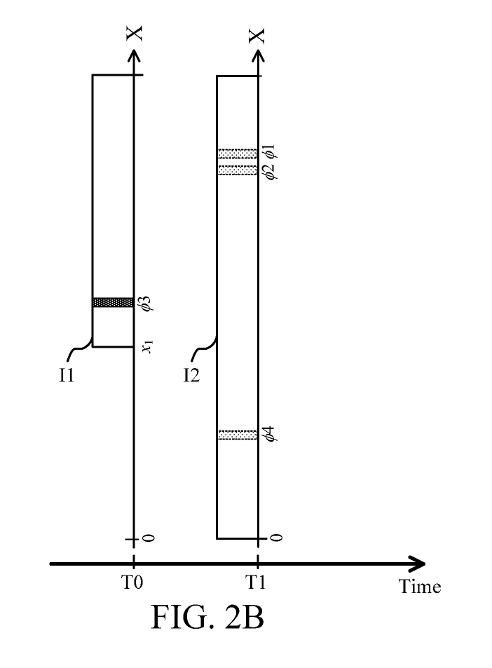

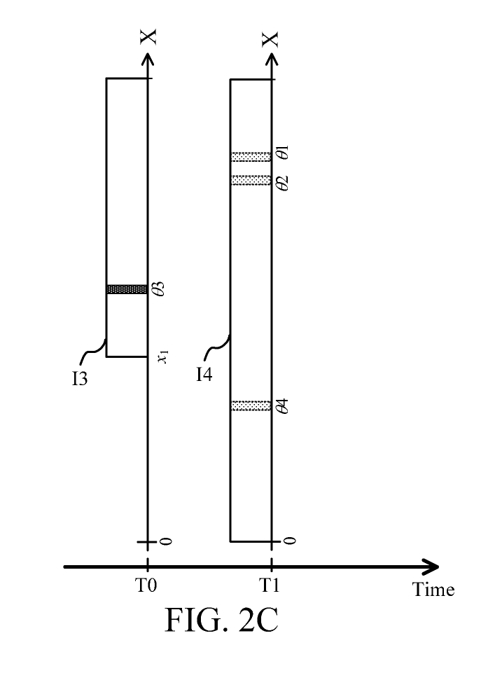

As shown in FIG. 2A, the solid line refers to that the controlling/processing unit 11 turns on the first light-emitting unit 122 to form the first field of light and the input points P1 and P2 obstruct the pathways of the light to the first image-capturing unit 16 and the second image-capturing unit 18 at time T0. Moreover, the dashed line in FIG. 2A refers to that the controlling/processing unit 11 turns on the second light-emitting unit 124, the third light-emitting unit 126 and the fourth light-emitting unit 128 to form the second field of light and the input points P1 and P2 obstruct the pathways of the light to the first image-capturing unit 16 and the second image-capturing unit 18 at time T1.

As shown in FIG. 2A, the pathways of the input points P1 and P2 obstruct the light to the first image-capturing unit 16 at time T0 and T1 form four angular vectors φ1, φ2, φ3 and φ4. As shown in FIG. 2B, at time T0, the first image-capturing unit 16 captures the image I1 related to the first field of light which has the shadow of the real image of angular vector φ3. At time T1, the first image-capturing unit 16 captures the image I2 related to the second field of light which has the shadows of the real images of angular vectors φ4 and the shadows of the mirror images of angular vectors φ1 and φ2.

As shown in FIG. 2A, the pathways of the input points P1 and P2 obstruct the light to the second image-capturing unit 18 at time T0 and T1 form four angular vectors θ1, θ2, θ3 and θ4. As shown in FIG. 2C, at time T0, the second image-capturing unit 18 captures the image I3 related to the first field of light which has the shadow of the real image of angular vector θ3. At time T1, the second image-capturing unit 18 captures the image I4 related to the second field of light which has the shadow of the real image of angular vector θ4 and the shadows of the mirror images of angular vector θ1 and θ2.

Obviously, the object-detecting system 1 of the invention can preciously calculate the locations of the input points P1 and P2 of FIG. 2A by analyzing the angular vectors indicated by the shadows in image I1, I2, I3 and I4. Particularly, both of the first image-capturing unit 16 and the second image-capturing unit 18 of the invention can be single-line image sensors. Accordingly, it is unnecessary to use an expansive image sensor or a waveguide device which may reduce the clarity of screen in the object-detecting system of the invention. Moreover, the object-detecting system can help the image sensor to sense the right field of light.

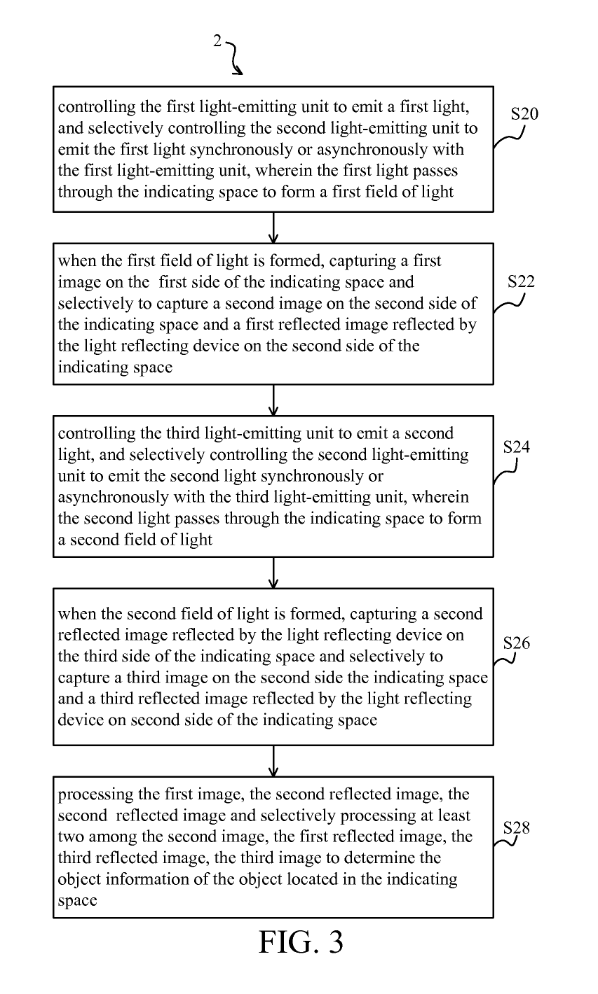

Please refer to FIG. 3, which illustrates a flow chart of an object-detecting method 2 according to the second preferred embodiment of the invention. The basic elements to perform the object-detecting method 2 of the invention include a peripheral member, a light-reflecting device, a first light-emitting unit, a second light-emitting unit, and a third light-emitting unit. The peripheral member defines an indicating space and an indicating plane of the indicating space on which an object directs a target position. The peripheral member has a relationship with the object. The indicating plane has a first side, a second side adjacent to the first side, a third side adjacent to the second side, and a fourth side adjacent to the third side and the first side. The third side and the fourth side form a first edge, and the second side and the third side form a second edge. The light-reflecting device is disposed on the peripheral member and located at the first side. The first light-emitting unit is disposed on the peripheral member, and located at the first side. The second light-emitting unit is disposed on the peripheral member, and located at the second side. The third light-emitting unit is disposed on the peripheral member, and located at the third side. Embodiments of the first light-emitting unit, the second light-emitting unit, the third light-emitting unit, and the light-reflecting device are as shown and illustrated in FIGS. 1A and 1B, and discussion of unnecessary details will be hereby omitted.

As shown in FIG. 3, the object-detecting method 2 according to the invention first performs step S20 to control the first light-emitting unit to emit a first light, and selectively to control the second light-emitting unit to emit the first light synchronously or asynchronously with the first light-emitting unit, where the first light passes through the indicating space to form a first field of light.

Then, the object-detecting method 2 according to the invention performs step S22 to capture a first image on the first side of the indicating space, and selectively to capture a second image on the second side of the indicating space and a first reflected image reflected by the light reflecting device on the second side of the indicating space when the first field of light is formed.

Afterward, the object-detecting method 2 according to the invention performs step S24 to control the third light-emitting unit to emit a second light, and selectively to control the second light-emitting unit to emit the second light synchronously or asynchronously with the third light-emitting unit, where the second light passes through the indicating space to form a second field of light.

Then, the object-detecting method 2 according to the invention performs step S26 to capture a second reflected image reflected by the light reflecting device on the third side of the indicating space, and selectively to capture a third image on the second side of the indicating space and a third reflected image reflected by the light reflecting device on the second side of the indicating space when the second field of light is formed.

Finally, the object-detecting method 2 according to the invention performs step S28 to process the first image, the second reflected image, and selectively to process at least two among the second image, the first reflected image, the third reflected image, the third image to determine the object information of the object located in the indicating space. The availability and determination regarding the object information are as described above, and discussion of unnecessary details will be hereby omitted.

To improve the quality of the captured images the object-detecting method 2, in one embodiment, a plurality of operation times are provided. Each of the operation times includes at least one exposure time. Each of the first light-emitting unit, the second light-emitting unit and the third light-emitting unit corresponds to at least one of the exposure times. Step S20 and step S24 are performed further to control each of the light-emitting units to emit the first light and/or the second light in accordance with the at least one exposure time corresponding to said one light-emitting unit. Moreover, step S22 and step S26 are performed further to capture the images within each of the operation times. The settings of the operation times and the exposure times are as described above, and discussion of unnecessary details will be hereby omitted.

To enhance the accuracy of the object-detecting method 2, in one embodiment, a fourth light-emitting unit is located at the fourth side. Step S20 is performed further to selectively control the fourth light-emitting unit to emit the first light synchronously or asynchronously with the first light-emitting unit. Step S22 is performed further to capture a fourth image on the first side of the indicating space and selectively capture a fifth image on the fourth side of the indicating space and a fourth reflected image reflected by the light-reflecting device on the fourth side of the indicating space. Step S24 is performed further to selectively control the fourth light-emitting unit to emit the second light synchronously or asynchronously with the third light-emitting unit. Step S26 is performed further to capture a fifth reflected image of portion reflected by the light-reflecting device on the third side of the indicating space and selectively capture a sixth image on the fourth side of the indicating space and a sixth reflected image reflected by the light-reflecting device on fourth side of the indicating space. Step S28 is performed further to process the first image, the second reflected image, the fourth image and the fifth reflected image and selectively process at least two among the second image, the first reflected image, the third reflected image, the third image, the fifth image, the fourth reflected image, the sixth image and the sixth reflected image to determine the object information of the object located in the indicating space. Furthermore, to improve the quality of the captured images the object-detecting method 2, the operation times and the exposure times mentioned above can be used in the embodiment.

In one embodiment, the first image, the second image, the third image, the first reflected image, the second reflected image and the third reflected image can be captured by a single-line image sensor. Moreover, the fourth image, the fifth image, the sixth image, the fourth reflected image, the fifth reflected image and the sixth reflected image can be captured by another line image sensor.

Please refer to FIG. 1A and FIG. 1B again, an object-detecting system 1 according to the third preferred embodiment of the invention is schematically illustrated in those figures.

As shown in FIG. 1A, an indicating plane 10 is defined where an object directs a target position. The object-detecting system 1 according to the third preferred embodiment of the invention includes a first image-capturing unit 16, a plurality of light-emitting units and a controlling/processing unit 11.

The first image-capturing unit is disposed around a first edge C1 of the indicating plane 10. The plurality of light-emitting units are disposed around a peripheral of the indicating plane 10. The controlling/processing unit 11 stores a plurality of operation times. Each of the operation time comprising at least one exposure time, each of the light-emitting units corresponds to at least one of the exposure times. The controlling/processing unit 11 controls each of the light-emitting units to emit light in accordance with the at least one exposure time corresponding to said one light-emitting unit. The controlling/processing unit 11 also controls the first image-capturing unit 16 to capture images relative to the indicating plane 10 within each of the operation times. The settings of the operation times and the exposure times are as described above, and discussion of unnecessary details will be hereby omitted.

In one embodiment, also as shown in FIG. 1A and FIG. 1B, the object-detecting system 1 according to the third preferred embodiment of the invention further includes a peripheral member 14 and a light-reflecting device 13. The peripheral member 14 defines an indicating space and the indicating plane 10 of the indicating space. The peripheral member 14 has a relationship with the object. The indicating space defines a first side 102, a second side 104 adjacent to the first side 102, a third side adjacent 106 to the second side 104, and a fourth side 108 adjacent to the third side 106 and the first side 102. The third side 106 and the fourth side 108 form the first edge C1. The light-reflecting device 13 is located at the first side 102.

The plurality of light-emitting units include a first light-emitting unit 122, a second light-emitting unit 124 and a third light-emitting unit 126. The first light-emitting unit 122 is located at the first side 102. The first light-emitting unit 122 is controlled by the controlling/processing unit 11 to emit a first light which passes through the indicating space to form a first field of light. The second light-emitting unit 124 is located at the second side 104. The third light-emitting unit 126 is located at the third side 106. The third light-emitting unit 126 is controlled by the controlling/processing unit 11 to emit a second light which passes through the indicating space to form a second field of light. The second light-emitting unit 124 is controlled by the controlling/processing unit 11 to selectively emit the first light synchronously or asynchronously with the first light-emitting unit 122, or to selectively emit the second light synchronously or asynchronously with the third light-emitting unit 126.

The first image-capturing unit 16 defines a first image-capturing point. The first image-capturing unit 16 is controlled by the controlling/processing unit 11 to capture a first image on the first side 102 of the indicating space, and selectively capture a second image on the second side 104 of the indicating space and a first reflected image reflected by the light reflecting device 13 on the second side 104 of the indicating space when the first field of light is formed. The first image-capturing unit 16 is also controlled by the controlling/processing unit 11 to capture a second reflected image reflected by the light reflecting device 13 on the third side 106 of the indicating space and selectively capture a third image on the second side 104 of the indicating space and a third reflected image reflected by the light reflecting device 13 on the second side 104 of the indicating space when the second field of light is formed. Moreover, the controlling/processing unit 11 processes the first image and the second reflected image and selectively processes at least two among the second image, the first reflected image, the third image and the third reflected image to determine an object information of the object located in the indicating space. The availability and determination regarding the object information are as described above, and discussion of unnecessary details will be hereby omitted.

In one embodiment, also as shown in FIG. 1A and FIG. 1B, the second side 104 and the third side 106 form a second edge C2. The plurality of light-emitting units further include a fourth light-emitting unit 128. The fourth light-emitting unit 128 is located at the fourth side 108. The fourth light-emitting unit 128 is controlled by the controlling/processing unit 11 to selectively emit the first light synchronously or asynchronously with the first light-emitting unit 122, or to selectively emit the second light synchronously or asynchronously with the third light-emitting unit 126. The object-detecting system 1 according to the third preferred embodiment of the invention further includes a second image-capturing unit 18. The second image-capturing unit 18 is disposed around the second edge C2. The second image-capturing unit 18 defines a second image-capturing point. The second image-capturing unit 18 is controlled by the controlling/processing unit 11 to capture a fourth image on the first side 102 of the indicating space and selectively to capture a fifth image on the fourth side 108 the indicating space and a fourth reflected image reflected by the light reflecting device 13 on the fourth side 108 of the indicating space when the first field of light is formed. The second image-capturing unit is controlled by the controlling/processing unit 11 to capture a fifth reflected image reflected by the light reflecting device 13 on the third side 106 of the indicating space and selectively to capture a sixth image on the fourth side 108 of the indicating space and a sixth reflected image reflected by the light reflecting device 13 on the fourth side 108 of the indicating space when the second field of light is formed. Moreover, the controlling/processing unit 11 processes the first image, the second reflected image, the fourth image and the fifth reflected image and selectively processes at least two among the second image, the first reflected image, the third reflected image, the third image, the fifth image, the fourth reflected image, the sixth image and the sixth reflected image to determine the object information of the object located in the indicating space. Embodiments of the first light-emitting unit 122, the second light-emitting unit 124, the third light-emitting unit 126, the fourth light-emitting unit 128 and the light-reflecting device 13 are as shown and illustrated in FIGS. 1A and 1B, and discussion of unnecessary details will be hereby omitted.

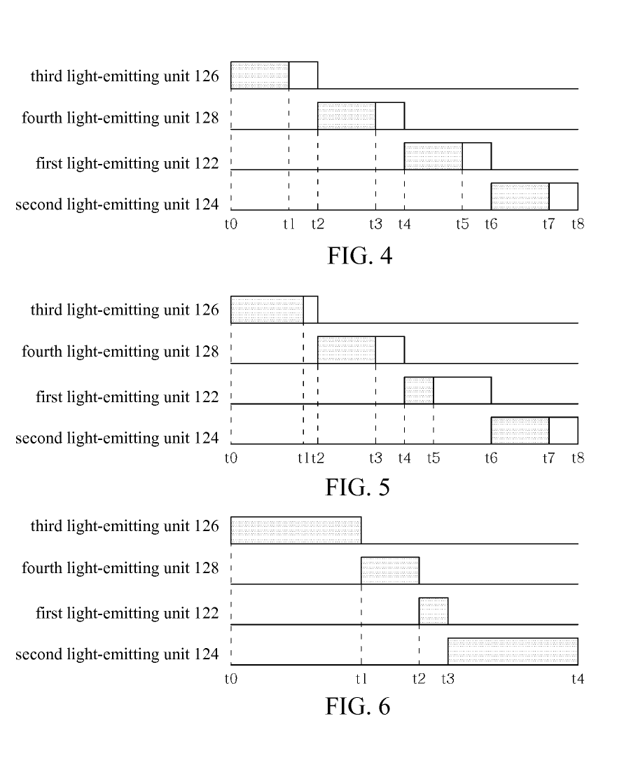

Please refer to FIG. 4, FIG. 4 is a timing diagram of the operation times and the exposure times of an example of the invention. As shown in FIG. 4, predetermined polling times are t0-t8. In this example, based on the first light-emitting unit 122, the second light-emitting unit 124, the third light-emitting unit 126 and the fourth light-emitting unit 128 as shown in FIG. 1A, the predetermined polling times t0-t8 are divided into four operation times including t0-t2, t2-t4, t4-t6 and t6-t8, and each of the operation times (t0-t2, t2-t4, t4-t6 and t6-t8) therein has an exposure time respectively set at t0-t1, t2-t3, t4-t5 and t6-t7. Each of the exposure times (t0-t1, t2-t3, t4-t5 and t6-t7) is respectively less than the corresponding operation time (t0-t2, t2-t4, t4-t6 and t6-t8). In this example, all of the operation times (t0-t2, t2-t4, t4-t6 and t6-t8) are equivalent and do not overlap one another, and all of the exposure times (t0-t1, t2-t3, t4-t5 and t6-t7) are equivalent. In this example, the controlling/processing unit 11 as shown in FIG. 1A according to each of the exposure times (t0-t1, t2-t3, t4-t5 and t6-t7) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t2, t2-t4, t4-t6 and t6-t8).

Please refer to FIG. 5, FIG. 5 is a timing diagram of the operation times and the exposure times of another example of the invention. As shown in FIG. 5, predetermined polling times are t0-t8. In this example, based on the first light-emitting unit 122, the second light-emitting unit 124, the third light-emitting unit 126 and the fourth light-emitting unit 128 as shown in FIG. 1A, the predetermined polling times t0-t8 are divided into four operation times including t0-t2, t2-t4, t4-t6 and t6-t8, and each of the operation times (t0-t2, t2-t4, t4-t6 and t6-t8) therein has an exposure time respectively set at t0-t1, t2-t3, t4-t5 and t6-t7. Each of the exposure times (t0-t1, t2-t3, t4-t5 and t6-t7) is respectively less than the corresponding operation time (t0-t2, t2-t4, t4-t6 and t6-t8). In this example, all of the operation times (t0-t2, t2-t4, t4-t6 and t6-t8) are equivalent and do not overlap one another, and at least one exposure time of the exposure times (t0-t1, t2-t3, t4-t5 and t6-t7) is not equivalent to the others. As show in FIG. 5, the exposure time t2-t3 is equivalent to the exposure time t6-t7, and not equivalent to the exposure times t0-t1 and t4-t5. In this example, the controlling/processing unit 11 as shown in FIG. 1A according to each of the exposure times (t0-t1, t2-t3, t4-t5 and t6-t7) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t2, t2-t4, t4-t6 and t6-t8).

Please refer to FIG. 6, FIG. 6 is a timing diagram of the operation times and the exposure times of another example of the invention. As shown in FIG. 6, predetermined polling times are t0-t4. In this example, based on the first light-emitting unit 122, the second light-emitting unit 124, the third light-emitting unit 126 and the fourth light-emitting unit 128 as shown in FIG. 1A, the predetermined polling times t0-t4 are divided into four operation times including t0-t1, t1-t2, t2-t3 and t3-t4, and each of the operation times (t0-t1, t1-t2, t2-t3 and t3-t4) therein has an exposure time respectively set at t0-t1, t1-t2, t2-t3 and t3-t4. That is to say that each of the exposure times (t0-t1, t1-t2, t2-t3 and t3-t4) is respectively equivalent to the corresponding operation time (t0-t1, t1-t2, t2-t3 and t3-t4). In this example, all of the operation times (t0-t1, t1-t2, t2-t3 and t3-t4) do not overlap one another, at least one operation time of the operation times (t0-t1, t1-t2, t2-t3 and t3-t4) is not equivalent to the others, and at least one exposure time of the exposure times (t0-t1, t1-t2, t2-t3 and t3-t4) is not equivalent to the others. As show in FIG. 6, the operation time t0-t1 is equivalent to the operation time t3-t4, and not equivalent to the operation times t1-t2 and t2-t3; the exposure time t0-t1 is equivalent to the exposure time t3-t4, and not equivalent to the exposure times t1-t2 and t2-t3. In this example, the controlling/processing unit 11 as shown in FIG. 1A according to each of the exposure times (t0-t1, t1-t2, t2-t3 and t3-t4) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t1, t1-t2, t2-t3 and t3-t4).

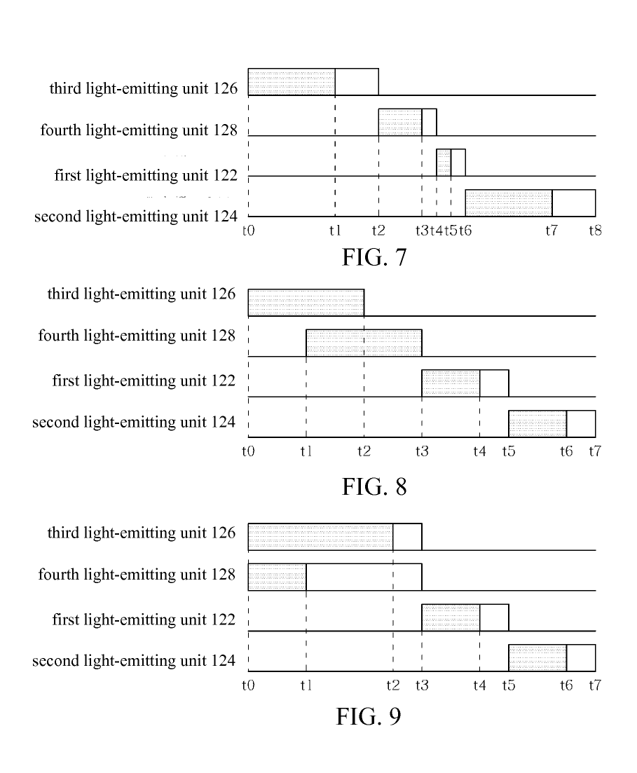

Please refer to FIG. 7, FIG. 7 is a timing diagram of the operation times and the exposure times of another example of the invention. As shown in FIG. 7, predetermined polling times are t0-t8. In this example, based on the first light-emitting unit 122, the second light-emitting unit 124, the third light-emitting unit 126 and the fourth light-emitting unit 128 as shown in FIG. 1A, the predetermined polling times t0-t8 are divided into four operation times including t0-t2, t2-t4, t4-t6 and t6-t8, and each of the operation times (t0-t2, t2-t4, t4-t6 and t6-t8) therein has an exposure time respectively set at t0-t1, t2-t3, t4-t5 and t6-t7. Each of the exposure times (t0-t1, t2-t3, t4-t5 and t6-t7) is respectively less than the corresponding operation time (t0-t2, t2-t4, t4-t6 and t6-t8). In this example, all of the operation times (t0-t2, t2-t4, t4-t6 and t6-t8) do not overlap one another, at least one operation time of the operation times (t0-t2, t2-t4, t4-t6 and t6-t8) is not equivalent to the others, and at least one exposure time of the exposure times (t0-t1, t2-t3, t4-t5 and t6-t7) is not equivalent to the others. As show in FIG. 7, the operation time t0-t2 is equivalent to the operation time t6-t8, and not equivalent to the operation times t2-t4 and t4-t6; the exposure time t0-t1 is equivalent to the exposure time t6-t7, and not equivalent to the exposure times t2-t3 and t4-t5. In this example, the controlling/processing unit 11 as shown in FIG. 1A according to each of the exposure times (t0-t1, t2-t3, t4-t5 and t6-t7) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t2, t2-t4, t4-t6 and t6-t8).

Please refer to FIG. 8, FIG. 8 is a timing diagram of the operation times and the exposure times of another example of the invention. As shown in FIG. 8, predetermined polling times are t0-t7. In this example, based on the first light-emitting unit 122, the second light-emitting unit 124, the third light-emitting unit 126 and the fourth light-emitting unit 128 as shown in FIG. 1A, the predetermined polling times t0-t7 are divided into four operation times including t0-t2, t1-t3, t3-t5 and t5-t7, and each of the operation times (t0-t2, t1-t3, t3-t5 and t5-t7) therein has an exposure time respectively set at t0-t2, t1-t3, t3-t4 and t5-t6. The exposure times t0-t2 and t1-t3 are respectively equivalent to the corresponding operation times t0-t2 and t1-t3, and the exposure times t3-t4 and t5-t6 are respectively less than the corresponding operation times t3-t5 and t5-t7. In this example, at least two of the operation times (t0-t2, t1-t3, t3-t5 and t5-t7) overlap partially. As show in FIG. 8, the operation time t0-t2 and the operation time t1-t3 overlap partially (the overlapped portion is t1-t2). In this example, the controlling/processing unit 11 as shown in FIG. 1A according to each of the exposure times (t0-t2, t1-t3, t3-t4 and t5-t6) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t2, t1-t3, t3-t5 and t5-t7).

That is, if it is estimated that the brightness required by the third light-emitting unit 126 and the fourth light-emitting unit 128 is maximum in accordance with the fixed noise of the image captured by the first image-capturing unit 16, the quality of image as desired and other effects, the operation times corresponding to the third light-emitting unit 126 and the fourth light-emitting unit 128 can be set to overlap partially, as shown in FIG. 8. Thereby, the exposure times of the third light-emitting unit 126 and the fourth light-emitting unit 128 can be extend within the fixed polling times to meet the requirement of brightness.

Please refer to FIG. 9, FIG. 9 is a timing diagram of the operation times and the exposure times of another example of the invention. As shown in FIG. 9, predetermined polling times are t0-t7. In this example, the predetermined polling times t0-t7 are divided into three operation times including t0-t3, t3-t5 and t5-t7. The operation time t0-t3 therein has two exposure times t0-t2 and t0-t1, the operation time t3-t5 therein has an exposure time t3-t4, and the operation time t5-t7 therein has an exposure time t5-t6. The exposure times t0-t2, t0-t1, t3-t4 and t5-t6 are respectively less than the corresponding operation times t0-t3, t3-t5 and t5-t7. In this example, the exposure times t0-t2 and t0-t1 in the operation time t0-t3 overlap partially (the overlapped portion is t0-t1), and respectively correspond to the third light-emitting unit 126 and the fourth light-emitting unit 128, as shown in FIG. 9. In this example, the controlling/processing unit 11 as shown in FIG. 1A according to each of the exposure times (t0-t2, t0-t1, t3-t4 and t5-t6) respectively controls the third light-emitting unit 126, the fourth light-emitting unit 128, the first light-emitting unit 122 and the second light-emitting unit 124 to emit light, and controls the first image-capturing unit 16 and the second image-capturing unit 18 as shown in FIG. 1A to capture images relative to the indicating plane 10 within the corresponding operation times (t0-t3, t3-t5 and t5-t7).

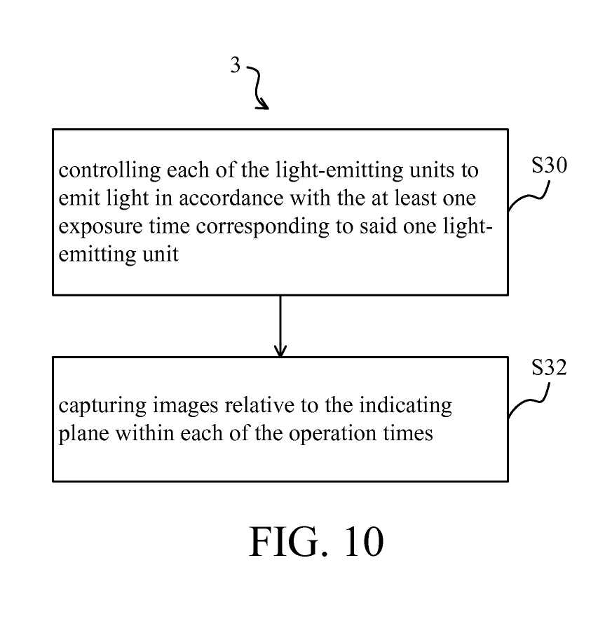

Please refer to FIG. 10, which illustrates a flow chart of an object-detecting method 3 according to the fourth preferred embodiment of the invention. The basic elements and conditions to perform the object-detecting method 3 of the invention includes an indicating plane on which an object directs a target position, a plurality of light-emitting units disposed around a peripheral of the indicating plane, and a plurality of operation times. Each of the operation time has at least one exposure time. Each of the light-emitting units corresponds to at least one of the exposure times.

As shown in FIG. 10, the object-detecting method 3 according to the fourth preferred embodiment of the invention first performs step S30 to control each of the light-emitting units to emit light in accordance with the at least one exposure time corresponding to said one light-emitting unit. Finally, the object-detecting method 3 according to the invention first performs step S32 to capture images relative to the indicating plane within each of the operation times. The settings of the operation times and the exposure times are as described above, and discussion of unnecessary details will be hereby omitted.

In one embodiment, a peripheral member defines an indicating space and the indicating plane of the indicating space. The peripheral member has a relationship with the object. The indicating space defines a first side, a second side adjacent to the first side, a third side adjacent to the second side, and a fourth side adjacent to the third side and the first side. A light-reflecting device is disposed on the peripheral member and located at the first side. The plurality of light-emitting units includes a first light-emitting unit, a second light-emitting unit and a third light-emitting unit. The first light-emitting unit is located at the first side. The second light-emitting unit is located at the second side. The third light-emitting unit is located at the third side. Step S30 in the object-detecting method 3 is performed by the steps of: (S30a) according to the at least one exposure time corresponding to the first light-emitting unit and the second light-emitting unit, controlling the first light-emitting unit to emit a first light, and selectively controlling the second light-emitting unit to emit the first light synchronously or asynchronously with the first light-emitting unit, where the first light passes through the indicating space to form a first field of light; and (S30b) according to the at least one exposure time corresponding to the third light-emitting unit and the second light-emitting unit, controlling the third light-emitting unit to emit a second light, and selectively controlling the second light-emitting unit to emit the second light synchronously or asynchronously with the third light-emitting unit, where the second light passes through the indicating space to form a second field of light. Moreover, step S32 is performed by the steps of: (S32a) when the first field of light is formed, capturing within each of the operation times a first image on the first side of the indicating space and selectively to capture a second image on the second side of the indicating space and a first reflected image reflected by the light reflecting device on the second side of the indicating space; and (32b) when the second field of light is formed, capturing within each of the operation times a second reflected image reflected by the light reflecting device on the third side of the indicating space and selectively to capture a third image on the second side of the indicating space and a third reflected image reflected by the light reflecting device on second side of the indicating space. The object-detecting method 3 according to the fourth preferred embodiment of the invention further includes the step of processing the first image, the second reflected image, the second reflected image and selectively processing at least two among the second image, the first reflected image, the third reflected image, the third image to determine the object information of the object located in the indicating space.

In one embodiment, the plurality of light-emitting units further includes a fourth light-emitting unit located at the fourth side. Step S30a is performed further to selectively control the fourth light-emitting unit to emit the first light synchronously or asynchronously with the first light-emitting unit. Step S32b is performed further to capture a fourth image on the first side of the indicating space and selectively capture a fifth image on the fourth side the indicating space and a fourth reflected image reflected by the light-reflecting device on the fourth side of the indicating space. Step 30b is performed further to selectively control the fourth light-emitting unit to emit the second light synchronously or asynchronously with the third light-emitting unit. Step 32b is performed further to capture a fifth reflected image of portion reflected by the light-reflecting device on the third side of the indicating space and selectively capture a sixth image r on the fourth side of the indicating space and a sixth reflected image reflected by the light-reflecting device on fourth side of the indicating space. The determination of the object information of the object is performed further to process the first image, the second reflected image, the fourth image and the fifth reflected image and selectively process at least two among the second image, the first reflected image, the third reflected image, the third image, the fifth image, the fourth reflected image, the sixth image and the sixth reflected image to determine the object information of the object located in the indicating space. Embodiments of the first light-emitting unit, the second light-emitting unit, the third light-emitting unit, the fourth light-emitting unit and the light-reflecting device are as shown and illustrated in FIGS. 1A and 1B, and discussion of unnecessary details will be hereby omitted.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An object-detecting system, comprising:
a peripheral member, the peripheral member defining an indicating space and an indicating plane of the indicating space on which an object directs a target position, the indicating space defining a first side, a second side adjacent to the first side, a third side adjacent to the second side, and a fourth side adjacent to the third side and the first side, the third side and the fourth side forming a first edge;
a light-reflecting device, disposed on the peripheral member and located at the first side;
a controlling/processing unit;
a first light-emitting unit located at the first side, the first light-emitting unit being controlled by the controlling/processing unit to emit a first light, the first light passing through the indicating space to form a first field of light;
a second light-emitting unit located at the second side;
a third light-emitting unit located at the third side, the third light-emitting unit being controlled by the controlling/processing unit to emit a second light, the second light passing through the indicating space to form a second field of light, wherein the second light-emitting unit is controlled by the controlling/processing unit to selectively emit the first light synchronously or asynchronously with the first light-emitting unit, or to selectively emit the second light synchronously or asynchronously with the third light-emitting unit; and
a first image-capturing unit disposed around the first edge, the first image-capturing unit being controlled by the controlling/processing unit to capture a first image on the first side of the indicating space, and selectively capture a second image on the second side of the indicating space and a first reflected image reflected by the light reflecting device on the second side of the indicating space when the first field of light is formed, the first image-capturing unit being also controlled by the controlling/processing unit to capture a second reflected image reflected by the light reflecting device on the third side of the indicating space and selectively capture a third image on the second side of the indicating space and a third reflected image reflected by the light reflecting device on the second side of the indicating space when the second field of light is formed;
wherein the controlling/processing unit processes the first image and the second reflected image and selectively processes at least two among the second image, the first reflected image, the third image and the third reflected image to determine an object information of the object located in the indicating space.

2. The object-detecting system of claim 1, wherein the light-reflecting device is a plane mirror or a prism.

3. The object-detecting system of claim 1, wherein the object information is a relative position of the target position relating to the indicating space, an object shape and/or an object area of the object projected on the indicating space, or an object stereo-shape and/or an object volume of the object located in the indicating space.

4. The object-detecting system of claim 1, wherein the controlling/processing unit stores a plurality of operation times, each of the operation time comprises at least one exposure time, and wherein each of the first light-emitting unit, the second light-emitting unit and the third light-emitting unit corresponds to at least one of the exposure times, the controlling/processing unit controls each of the light-emitting units to emit the first light and/or the second light in accordance with the at least one exposure time corresponding to said one light-emitting unit, the controlling/processing unit also controls the first image-capturing unit to capture the images within each of the operation times.

5. The object-detecting system of claim 4, wherein each of the exposure times is less than or equivalent to the operation time that said one exposure time is within.

6. The object-detecting system of claim 4, wherein all of the operation times are equivalent and do not overlap one another, and all of the exposure times are equivalent.

7. The object-detecting system of claim 4, wherein all of the operation times are equivalent and do not overlap one another, and at least one of the exposure times is not equivalent to the others.

8. The object-detecting system of claim 4, wherein at least two of the operation times overlap one another.

9. The object-detecting system of claim 1, the second side and the third side forming a second edge, said objecting-detecting system further comprising:
a fourth light-emitting unit, located at the fourth side, the fourth light-emitting unit being controlled by the controlling/processing unit to selectively emit the first light synchronously or asynchronously with the first light-emitting unit, or to selectively emit the second light synchronously or asynchronously with the third light-emitting unit; and
a second image-capturing unit disposed around the second edge, the second image-capturing unit defining a second image-capturing point, the second image-capturing unit being controlled by the controlling/processing unit to capture a fourth image on the first side of the indicating space and selectively to capture a fifth image on the fourth side of the indicating space and a fourth reflected image reflected by the light reflecting device on the fourth side of the indicating space when the first field of light is formed, the second image-capturing unit being controlled by the controlling/processing unit to capture a fifth reflected image reflected by the light reflecting device on the third side of the indicating space and selectively to capture a sixth image on the fourth side of the indicating space and a sixth reflected image reflected by the light reflecting device on the fourth side of the indicating space when the second field of light is formed;
wherein the controlling/processing unit processes the first image, the second reflected image, the fourth image and the fifth reflected image and selectively processes at least two among the second image, the first reflected image, the third reflected image, the third image, the fifth image, the fourth reflected image, the sixth image and the sixth reflected image to determine the object information of the object located in the indicating space.

10. The object-detecting system of claim 9, wherein the first image-capturing unit and/or the second image-capturing unit are respectively a line image sensor.

11. The object-detecting system of claim 9, wherein the controlling/processing unit stores a plurality of operation times, each of the operation times comprises at least one exposure time, the first image-capturing unit and the second image-capturing unit respectively correspond to at least one of the operation times, and each of the first light-emitting unit, the second light-emitting unit, the third light-emitting unit and the fourth light-emitting unit corresponds to at least one of the exposure times, the controlling/processing unit controls each of the light-emitting units to emit the first light and/or the second light in accordance with the at least one exposure time corresponding to said one light-emitting unit, the controlling/processing unit also controls the first image-capturing unit to capture the images within each of the operation times corresponding to the first image-capturing unit, and controls the second image-capturing unit to capture the images within each of the operation times corresponding to the second image-capturing unit.

12. An object-detecting method, a peripheral member defining an indicating space and an indicating plane of the indicating space on which an object directs a target position, the indicating space defining a first side, a second side adjacent to the first side, a third side adjacent to the second side, and a fourth side adjacent to the third side and the first side, a light-reflecting device being disposed on the peripheral member and located at the first side, a first light-emitting unit being located at the first side, a second light-emitting unit being located at the second side, a third light-emitting unit being located at the third side, said object-detecting method comprising the steps of:
(a) controlling the first light-emitting unit to emit a first light, and selectively controlling the second light-emitting unit to emit the first light synchronously or asynchronously with the first light-emitting unit, wherein the first light passes through the indicating space to form a first field of light;
(b) when the first field of light is formed, capturing a first image on the first side of the indicating space and selectively capturing a second image on the second side of the indicating space and a first reflected image reflected by the light reflecting device on the second side of the indicating space;
(c) controlling the third light-emitting unit to emit a second light, and selectively controlling the second light-emitting unit to emit the second light synchronously or asynchronously with the third light-emitting unit, wherein the second light passes through the indicating space to form a second field of light;
(d) when the second field of light is formed, capturing a second reflected image reflected by the light reflecting device on the third side of the indicating space and selectively capturing a third image on the second side of the indicating space and a third reflected image reflected by the light reflecting device on the second side of the indicating space; and
(e) processing the first image, the second reflected image, and selectively processing at least two among the second image, the first reflected image, the third reflected image, the third image to determine the object information of the object located in the indicating space.

13. The object-detecting method of claim 12, wherein the light-reflecting device is a plane mirror or a prism.

14. The object-detecting method of claim 12, wherein the object information is a relative position of the target position relating to the indicating space, an object shape and/or an object area of the object projected on the indicating space, or an object stereo-shape and/or an object volume of the object located in the indicating space.

15. The object-detecting method of claim 12, wherein a plurality of operation times are provided, each of the operation times comprises at least one exposure time, each of the first light-emitting unit, the second light-emitting unit and the third light-emitting unit corresponds to at least one of the exposure times, step (a) and step (c) are performed further to control each of the light-emitting units to emit the first light and/or the second light in accordance with the at least one exposure time corresponding to said one light-emitting unit, step (b) and step (d) are performed further to capture the images within each of the operation times.

16. The object-detecting method of claim 15, wherein each of the exposure times is less than or equivalent to the operation time that said one exposure time is within.

17. The object-detecting method of claim 15, wherein all of the operation times are equivalent and do not overlap one another, and all of the exposure times are equivalent.

18. The object-detecting method of claim 15, wherein all of the operation times are equivalent and do not overlap one another, and at least one of the exposure times is not equivalent to the others.

19. The object-detecting method of claim 15, wherein at least two of the operation times overlap one another.

20. The object-detecting method of claim 12, a fourth light-emitting unit being located at the fourth side, wherein step (a) is performed further to selectively control the fourth light-emitting unit to emit the first light synchronously or asynchronously with the first light-emitting unit, step (b) is performed further to capture a fourth image on the first side of the indicating space and selectively capture a fifth image on the fourth side of the indicating space and a fourth reflected image reflected by the light-reflecting device on the fourth side of the indicating space, step (c) is performed further to selectively control the fourth light-emitting unit to emit the second light synchronously or asynchronously with the third light-emitting unit, step (d) is performed further to capture a fifth reflected image of portion reflected by the light-reflecting device on the third side of the indicating space and selectively capture a sixth image on the fourth side of the indicating space and a sixth reflected image reflected by the light-reflecting device on fourth side of the indicating space, step (e) is performed further to process the first image, the second reflected image, the fourth image and the fifth reflected image and selectively process at least two among the second image, the first reflected image, the third reflected image, the third image, the fifth image, the fourth reflected image, the sixth image and the sixth reflected image to determine the object information of the object located in the indicating space.

21. The object-detecting method of claim 20, wherein the first image, the second image, the third image, the first reflected image, the second reflected image and the third reflected image are captured by a first line image sensor, and the fourth image, the fifth image, the sixth image, the fourth reflected image, the fifth reflected image and the sixth reflected image are captured by a second line image sensor.

22. The object-detecting method of claim 20, wherein a plurality of operation times are provided, each of the operation times has at least one exposure time, each of the first light-emitting unit, the second light-emitting unit, the third light-emitting unit and the fourth light-emitting unit corresponds to at least one of the exposure times, step (a) and step (c) are performed further to control each of the light-emitting units to emit the first light and/or the second light in accordance with the at least one exposure time corresponding to said one light-emitting unit, step (b) and step (d) are performed further to capture the images within each of the operation times.

23. An object-detecting system, an indicating plane, on which an object directs a target position, being defining, said object-detecting system comprising:
a first image-capturing unit, disposed around a first edge of the indicating plane;
a plurality of light-emitting units, disposed around a peripheral of the indicating plane; and
a controlling/processing unit storing a plurality of operation times, each of the operation time comprising at least one exposure time, each of the light-emitting units corresponding to at least one of the exposure times, the controlling/processing unit controlling each of the light-emitting units to emit light in accordance with the at least one exposure time corresponding to said one light-emitting unit, the controlling/processing unit also controlling the first image-capturing unit to capture images relative to the indicating plane within each of the operation times.

24. The object-detecting system of claim 23, wherein each of the exposure times is less than or equivalent to the operation time that said one exposure time is within.

25. The object-detecting system of claim 23, wherein all of the operation times are equivalent and do not overlap one another, and all of the exposure times are equivalent.

26. The object-detecting system of claim 23, wherein all of the operation times are equivalent and do not overlap one another, and at least one of the exposure times is not equivalent to the others.

27. The object-detecting system of claim 23, wherein at least two of the operation times overlap one another.

28. The object-detecting system of claim 23, further comprising:
a peripheral member, the peripheral member defining an indicating space and the indicating plane of the indicating space, the indicating space defining a first side, a second side adjacent to the first side, a third side adjacent to the second side, and a fourth side adjacent to the third side and the first side, the third side and the fourth side forming the first edge; and
a light-reflecting device located at the first side;
wherein the plurality of light-emitting units comprise:
a first light-emitting unit located at the first side, the first light-emitting unit being controlled by the controlling/processing unit to emit a first light, the first light passing through the indicating space to form a first field of light;
a second light-emitting unit located at the second side; and
a third light-emitting unit located at the third side, the third light-emitting unit being controlled by the controlling/processing unit to emit a second light, the second light passing through the indicating space to form a second field of light, wherein the second light-emitting unit is controlled by the controlling/processing unit to selectively emit the first light synchronously or asynchronously with the first light-emitting unit, or to selectively emit the second light synchronously or asynchronously with the third light-emitting unit;
wherein the first image-capturing unit defines a first image-capturing point, the first image-capturing unit is controlled by the controlling/processing unit to capture a first image on the first side of the indicating space, and selectively capture a second image on the second side of the indicating space and a first reflected image reflected by the light reflecting device on the second side of the indicating space when the first field of light is formed, the first image-capturing unit is also controlled by the controlling/processing unit to capture a second reflected image reflected by the light reflecting device on the third side of the indicating space and selectively capture a third image on the second side of the indicating space and a third reflected image reflected by the light reflecting device on the second side of the indicating space when the second field of light is formed; and
wherein the controlling/processing unit processes the first image and the second reflected image and selectively processes at least two among the second image, the first reflected image, the third image and the third reflected image to determine an object information of the object located in the indicating space.

29. The object-detecting system of claim 28, wherein the light-reflecting device is a plane mirror or a prism.

30. The object-detecting system of claim 28, wherein the object information is a relative position of the target position relating to the indicating space, an object shape and/or an object area of the object projected on the indicating space, or an object stereo-shape and/or an object volume of the object located in the indicating space.

31. The object-detecting system of claim 28, the second side and the third side forming a second edge, the plurality of light-emitting units further comprising:
a fourth light-emitting unit located at the fourth side, the fourth light-emitting unit being controlled by the controlling/processing unit to selectively emit the first light synchronously or asynchronously with the first light-emitting unit, or to selectively emit the second light synchronously or asynchronously with the third light-emitting unit;
said objecting-detecting system further comprising:
a second image-capturing unit disposed around the second edge, the second image-capturing unit defining a second image-capturing point, the second image-capturing unit being controlled by the controlling/processing unit to capture a fourth image on the first side of the indicating space and selectively to capture a fifth image on the fourth side the indicating space and a fourth reflected image reflected by the light reflecting device on the fourth side of the indicating space when the first field of light is formed, the second image-capturing unit being controlled by the controlling/processing unit to capture a fifth reflected image reflected by the light reflecting device on the third side of the indicating space and selectively to capture a sixth image on the fourth side of the indicating space and a sixth reflected image reflected by the light reflecting device on the fourth side of the indicating space when the second field of light is formed;
wherein the controlling/processing unit processes the first image, the second reflected image, the fourth image and the fifth reflected image and selectively processes at least two among the second image, the first reflected image, the third reflected image, the third image, the fifth image, the fourth reflected image, the sixth image and the sixth reflected image to determine the object information of the object located in the indicating space.

32. The object-detecting system of claim 31, wherein the first image-capturing unit and/or the second image-capturing unit are respectively a line image sensor.

33. The object-detecting system of claim 31, wherein the first image-capturing unit and the second image-capturing unit respectively correspond to at least one of the operation times, the controlling/processing unit controls each of the light-emitting units to emit the first light and/or the second light in accordance with the at least one exposure time corresponding to said one light-emitting unit, the controlling/processing unit also controls the first image-capturing unit to capture the images within each of the operation times corresponding to the first image-capturing unit, and controls the second image-capturing unit to capture the images within each of the operation times corresponding to the second image-capturing unit.

34. An object-detecting method, an indicating plane, on which an object directs a target position, being defining, a plurality of light-emitting units being disposed around a peripheral of the indicating plane, a plurality of operation times being provided, each of the operation time having at least one exposure time, each of the light-emitting units corresponding to at least one of the exposure times, said object-detecting method comprising the steps of:
(a) controlling each of the light-emitting units to emit light in accordance with the at least one exposure time corresponding to said one light-emitting unit; and
(b) capturing images relative to the indicating plane within each of the operation times.

35. The object-detecting method of claim 34, wherein each of the exposure times is less than or equivalent to the operation time that said one exposure time is within.

36. The object-detecting method of claim 34, wherein all of the operation times are equivalent and do not overlap one another, and all of the exposure times are equivalent.

37. The object-detecting method of claim 34, wherein all of the operation times are equivalent and do not overlap one another, and at least one of the exposure times is not equivalent to the others.

38. The object-detecting method of claim 34, wherein at least two of the operation times overlap one another.

39. The object-detecting method of claim 34, a peripheral member defining an indicating space and the indicating plane of the indicating space, the indicating space defining a first side, a second side adjacent to the first side, a third side adjacent to the second side, and a fourth side adjacent to the third side, a light-reflecting device being disposed on the peripheral member and located at the first side, the plurality of light-emitting units comprising a first light-emitting unit, a second light-emitting unit and a third light-emitting unit, the first light-emitting unit being located at the first side, the second light-emitting unit being located at the second side, the third light-emitting unit being located at the third side, step (a) being performed by the steps of:
(a1) according to the at least one exposure time corresponding to the first light-emitting unit and the second light-emitting unit, controlling the first light-emitting unit to emit a first light, and selectively controlling the second light-emitting unit to emit the first light synchronously or asynchronously with the first light-emitting unit, wherein the first light passes through the indicating space to form a first field of light; and
(a2) according to the at least one exposure time corresponding to the third light-emitting unit and the second light-emitting unit, controlling the third light-emitting unit to emit a second light, and selectively controlling the second light-emitting unit to emit the second light synchronously or asynchronously with the third light-emitting unit, wherein the second light passes through the indicating space to form a second field of light;
step (b) being performed by the steps of:
(b1) when the first field of light is formed, capturing within each of the operation times a first image on the first side of the indicating space and selectively to capture a second image on the second side of the indicating space and a first reflected image reflected by the light reflecting device on the second side of the indicating space; and
(b2) when the second field of light is formed, capturing within each of the operation times a second reflected image reflected by the light reflecting device on the third side of the indicating space and selectively to capture a third image on the second side of the indicating space and a third reflected image reflected by the light reflecting device on second side of the indicating space;
said object-detecting method further comprising the step of
(c) processing the first image, the second reflected image, the second reflected image and selectively processing at least two among the second image, the first reflected image, the third reflected image, the third image to determine the object information of the object located in the indicating space.

40. The object-detecting method of claim 39, wherein the light-reflecting device is a plane minor or a prism.

41. The object-detecting method of claim 39, wherein the object information is a relative position of the target position relating to the indicating space, an object shape and/or an object area of the object projected on the indicating space, or an object stereo-shape and/or an object volume of the object located in the indicating space.

42. The object-detecting method of claim 39, the plurality of light-emitting units further comprising a fourth light-emitting unit located at the fourth side, step (a1) is performed further to selectively control the fourth light-emitting unit to emit the first light synchronously or asynchronously with the first light-emitting unit, step (b1) is performed further to capture a fourth image on the first side of the indicating space and selectively capture a fifth image on the fourth side the indicating space and a fourth reflected image reflected by the light-reflecting device on the fourth side of the indicating space, step (a2) is performed further to selectively control the fourth light-emitting unit to emit the second light synchronously or asynchronously with the third light-emitting unit, step (b2) is performed further to capture a fifth reflected image of portion reflected by the light-reflecting device on the third side of the indicating space and selectively capture a sixth image r on the fourth side of the indicating space and a sixth reflected image reflected by the light-reflecting device on fourth side of the indicating space, step (c) is performed further to process the first image, the second reflected image, the fourth image and the fifth reflected image and selectively process at least two among the second image, the first reflected image, the third reflected image, the third image, the fifth image, the fourth reflected image, the sixth image and the sixth reflected image to determine the object information of the object located in the indicating space.

43. The object-detecting method of claim 42, wherein the first image, the second image, the third image, the first reflected image, the second reflected image and the third reflected image are captured by a first line image sensor, and the fourth image, the fifth image, the sixth image, the fourth reflected image, the fifth reflected image and the sixth reflected image are captured by a second line image sensor.
